(19) United States
(12) Patent Application Publication
(10) Pub. No.: US 2015/0380150 A1
(43) Pub. Date: Dec. 31, 2015

(54) Electric Transformer Component

(71) Applicant: EPCOS AG, München (DE)

(72) Inventors: Uwe Sommer, Neuried (DE); Michael Forster, Erding (DE); Bernhard Röllgen, München (DE); Karl Stoll, Germering (DE)

(21) Appl. No.: 14/765,798

(22) PCT Filed: Jan. 27, 2014
(86) PCT No.: PCT/EP2014/051525

§ 371 Date: Aug. 4, 2015

(30) Foreign Application Priority Data
Feb. 12, 2013 (DE) 10 2013 101 364.3

(51) Int. Cl. H01F 27/26; H01F 41/08; H01F 27/29

(52) U.S. Cl. CPC H01F 27/263; H01F 27/29; H01F 41/08

(57) ABSTRACT

An electrical transformer component includes a central limb having a first and a second end section and a central section, which is arranged between the first and second end sections. The component also includes an outer limb having a holding device for holding the central limb on the outer limb. At least one of the first and second end sections of the central limb is held on the holding device of the outer limb. At least two wires are wound directly onto part of the surface of the central section of the central limb.

This patent application is a national phase filing under section 371 of PCT/EP2014/051525, filed Jan. 27, 2014, which claims the priority of German patent application 10 2013 101 364.3, filed Feb. 12, 2013, each of which is incorporated herein by reference in its entirety.

### TECHNICAL FIELD

The invention relates to an electrical transformer component that can be used, for example, in the circuit of an ultrasonic echo distance sensor in the automotive sector.

### BACKGROUND

Ultrasonic echo distance sensors are used in the automotive sector in parking assistance systems for distance measurement between a vehicle and an object. A circuit of an ultrasonic echo distance sensor can have a transformer component, with which, in a transmission phase, a high AC voltage, which causes the ultrasonic echo distance sensor temporarily to perform a thickness-mode oscillation. In the reception phase following the transmission phase, the high impedance of the echo signal is transformed by the transformer component into a low impedance which is matched to the reception circuit of the sensor circuit, as a result of which even extremely small signals can be detected by the circuit with low levels of noise.

In order to receive the ultrasonic pulse reflected by objects, one and the same ultrasonic sensor can therefore be used, which usually has a disk consisting of a piezoelectric ceramic, for example, lead-zirconate-titanate (PZT). The low DC resistance of the primary winding of the transformer component ensures as little noise as possible in the reception mode of the circuit in the amplifier stage which amplifies the usually very weak reception signal. As an alternative to this, systems are conventional in which the reception signal can be picked off directly at a piezoelectric sensor. With circuits which use an EP transformer, for example, an EP5/EP6 transformer, only small ranges, for example, ranges of 3 m, can be achieved. This is generally also sufficient for parking assistance systems. Owing to the restricted ranges, such transformers generally cannot be used for distance warning in the driving mode, however. Any desired enlargement of ultrasonic echo distance sensors by which the achievable range could be increased is not possible in automobiles owing to the available installation space, however.

### SUMMARY

Embodiments specify an electrical transformer component that has a small physical size and with which large ranges can be achieved when used in combination with a circuit of a distance sensor. Further embodiments specify methods for producing such an electrical transformer component.

In accordance with a possible embodiment, the electrical transformer component comprises a central limb comprising a first and second end section and a central section, which is arranged between the first and second end sections. Furthermore, the electrical transformer component has an outer limb comprising a holding device for holding the central limb on the outer limb. In the transformer component, at least one of the first and second end sections of the central limb is held on the holding device of the outer limb. At least two wires are wound directly onto at least part of the surface of the central section of the central limb.

The outer limb can be in the form of an integral body comprising a base area and comprising at least one side wall. The base area and the at least one side wall are arranged in such a way that the integral body is in the form of a hollow body with a cavity. The hollow body or cavity is open on the side opposite the base area, with the result that the cavity is formed between the base area and the at least one side wall. The central limb is held on the outer limb by the holding device in such a way that at least part of the surface of the central limb is surrounded by the base area and the at least one side wall of the integral body. The central limb can be in the form of a rod core.

In accordance with a first embodiment, the at least two wires are wound directly onto the central limb, wherein at least a first of the at least two wires forms the primary winding and at least a second of the at least two wires forms the secondary winding of the transformer component. A transformer component with such a design can be used in an existing circuit of a distance sensor as a replacement for conventional EP transformers without modifications needing to be made to the existing application circuit for this purpose. In comparison with the use of EP transformers, however, much larger ranges can be achieved when using distance sensors with the specified electrical transformer component as a result of the higher saturation limit of the transformer component in comparison with the EP transformer, however. Furthermore, the installation space required for the transformer can be reduced since the wire can be wound directly onto the central limb of the transformer component. Since manual process steps are largely dispensed with, the manufacturing costs for such a transformer component are lower than in the case of conventional EP transformers.

In accordance with a second possible embodiment, the transformer component has a form of a coil former. The coil former comprises a contact-making device for making contact with a first of the at least two wires and a further contact-making device for making contact with a second of the at least two wires. In each case a flange is arranged laterally on the contact-making making element the two flanges and therefore also the two contact-making devices are connected to one another. The contact-making devices, the flanges and the support element can comprise the same material. When the transformer component is complete, the central limb is arranged between openings in the flanges and is supported with a central section on the support element. The two lateral end sections of the central limb which protrude out of the flanges are supported on the contact-making devices. The end sections of the central limb can be adhesively bonded to the contact-making devices. Likewise, the central section of the central limb can be fixed to the support element via an adhesive bond.

The support element is designed in such a way that part of the surface of the central section of the central limb is supported on the support element. A second part of the surface of the central section of the central limb is not supported on the support element. When a first and second wire of a primary and secondary winding is wound on, the electrical conductors are wound directly and immediately onto the first part of the surface of the central section of the central limb.

In accordance with a third possible embodiment, the electrical transformer component has a coil former comprising a central tube, which is arranged between two contact-making devices for terminating the wires of a primary and secondary winding and for applying a voltage to the wires.

The central tube can be formed from a first hollow cylinder and a second hollow cylinder, wherein the two hollow cylinders are connected via at least one material web. The web between the first and second hollow cylinders is not in the form of a hollow cylinder, but has only at least one segment of a hollow cylinder, for example. If the web comprises a plurality of segments of a hollow cylinder, the segments are arranged in such a way that there is an air gap between them. The first hollow cylinder can be connected to a first contact-making device for applying a voltage to the wire of the primary winding, and the second hollow cylinder can be connected to a second contact-making device for applying a voltage to the wire of the secondary winding. The central limb can be inserted into the central tube thus formed. When the at least two wires of the primary and secondary winding of the transformer component are wound on, the at least two wires are wound immediately onto the central section of the central limb apart from that section which is beneath the web. Likewise, the wires are arranged on the two hollow cylinders.

In contrast to an EP transformer, in which the central tube of the coil former is in the form of a tube which is completely closed circumferentially and in which a primary and secondary winding of at least two wires are not wound immediately onto a central limb inserted into the tube, but rather the wires of the primary and secondary winding are applied to the central tube of the coil former, in the present transformer component the at least two wires of the primary and secondary winding of the transformer component are wound immediately onto the central limb in the region between the first and second hollow cylinders. Even when now only laterally two hollow cylinders remain of the central tube which is closed circumferentially in the case of an EP transformer, the winding space is considerably enlarged. Since manufacturing tolerances are very large precisely in the case of small ferrite cores, the required supply for a core which is not particularly true to size needs to be provided in the coil former.

In the third embodiment, in which there are now only small hollow cylinders left over from the originally circumferentially closed central tube of an EP transformer, which small hollow cylinders are arranged on the first and second partial bodies, a previously used winding technology can be maintained. If the central tube is dispensed with entirely in the coil former, as in the first-mentioned embodiment, the winding space is enlarged again.

Owing to the higher turns number of the transformer component in comparison with an EP transformer, the cross section of the wires of the primary and secondary winding to be wound can be increased in comparison with an EP transformer component, which results in a lower resistance. With the higher turns number, transformer components with higher inductance values can be manufactured in comparison with an EP transformer. In order to achieve the same inductance value as in an EP transformer despite the application of a plurality of turns in the electrical transformer component, an air gap between the central limb and the outer limb can be enlarged. As a result, the storage capacity of the core is also increased. When using such an electrical transformer component in the circuit of a distance sensor, in particular an ultrasound echo distance sensor, the sonic sensor can output more energy than when using an EP transformer. Thus, the range of the distance sensor circuit can be enlarged.

### BRIEF DESCRIPTION OF THE DRAWINGS

Embodiments of the electrical transformer component and of methods for producing the electrical transformer component are explained in more detail below with reference to the figures, in which:

FIG. 1A shows core halves of an EP transformer;

FIG. 1B shows a coil former for an EP transformer;

FIG. 2 shows an embodiment of an outer limb of an electrical transformer component;

FIG. 3A shows an embodiment of a contact-making device comprising a central limb and an embodiment of an outer limb;

FIG. 3B shows an embodiment of an electrical transformer component;

FIG. 3C shows an embodiment of an outer limb with a central limb;

FIG. 4 shows an embodiment of an outer limb of an electrical transformer component;

FIG. 5A shows an embodiment of an electrical transformer component;

FIG. 5B shows an embodiment of an outer limb with a central limb;

FIG. 6 shows an embodiment of a contact-making device comprising a central limb having an air gap;

FIG. 7 shows an embodiment of a coil former comprising lateral flanges;

FIG. 8 shows a further embodiment of a coil former comprising an interrupted central tube;

FIG. 9 shows an embodiment of a method for producing an electrical transformer component; and

FIG. 10 shows a further embodiment of a method for producing an electrical transformer component.

Transformer components for distance sensors, in particular for ultrasound echo distance sensors, cannot be produced at sufficiently low cost on the basis of toroidal cores owing to the air gap which is inevitably required. Interference fields entering the toroidal core of the transformer from the outside are moreover distributed nonuniformly owing to the air gap present, with the result that compensating voltages would no longer be induced in total. Instead of using toroidal cores, electrical transformer components having an EP design, for example, EP5/EP6 transformers, are generally used in circuits for distance sensors.

### DETAILED DESCRIPTION OF ILLUSTRATIVE EMBODIMENTS

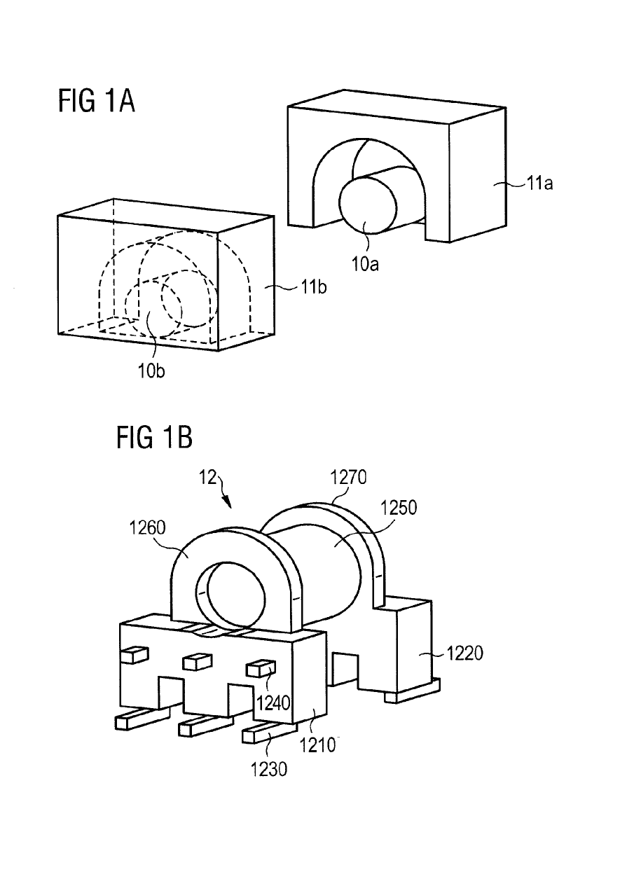

FIG. 1A shows an embodiment of a core for an EP transformer. The core comprises two core halves, wherein a first core half has a central limb 10a and an outer limb 11a. A further core half has a central limb 10b and an outer limb 11b.

FIG. 1B shows a coil former 12 for the EP transformer. The coil former has a contact-making device 1210 and a contact-making device 1220. Contact elements 1230 for applying a voltage to wires (not shown in FIG. 1B) of a primary and secondary winding of the transformer which can be wound onto a central tube 1250 of the coil former are located on the contact-making devices. Contact elements 1240 are used for terminating the wires and are connected to the contact elements 1230 in the interior of the contact-making devices 1210, 1220. The coil former has side parts/flanges 1260, 1270 at both ends of the central tube 1250. The side parts prevent the separate wires of the primary and secondary winding which are wound onto the central tube 1250 from being able to slide laterally off from the central tube.

Once the primary and secondary windings have been wound onto the central tube 1250 of the coil former 12, the two core halves with their central limbs 10a, 10b are inserted into the cavity of the central tube 1250. The two outer limbs 11a, 11b can be adhesively bonded to one another. The finished EP transformer therefore has two cores in the form of half-shells which are minor-symmetrical with respect to one another, for example, consisting of ferrite, and comprising metal limbs, which are connected to one another. The wires of the primary and secondary windings are located, wound onto the coil former 1250, in the interior of the cores 11a, 11b in the form of half-shells.

In general, in the case of a distance sensor, in particular in the case of an ultrasonic echo distance sensor, a push-pull stage integrated in an ASIC drives the two primary windings of an EP5/EP6 transformer. Alternatively, the driver can be realized by an H bridge and only one primary winding. The secondary winding of the transformer has a higher turns number than the primary windings. The secondary winding drives a piezoelectric sonic transducer having a high voltage corresponding to the turns ratio. The inductance of the secondary winding moreover forms, with the parasitic capacitance of the piezoelectric element, a parallel resonant circuit, which oscillates at a frequency of approximately 50 kHz, for example.

With such a circuit arrangement, a high sound pressure can be generated owing to the high voltage which can be achieved via the piezoelectric element. The circuit drives a piezoelectric loudspeaker only for a short period of time, however. As soon as the oscillation has decayed, the reception amplifier in the ASIC is connected to the primary windings/primary winding. Echoes or interference noise generate a signal with a low amplitude in the piezoelectric sensor, which signal is filtered by the secondary inductance of the EP transformer and the parasitic capacitance of the piezoelectric element and, reduced by the turns ratio of the transformer, is supplied to the reception amplifier in the ASIC at a low resistance and therefore with extremely low levels of noise.

The EP transformer shown in FIGS. 1A and 1B has, owing to the comparatively small physical size and its internal design with primary and secondary windings wound onto a coil former, a high DC resistance compared to larger transformers, with the result that an ultrasonic echo distance sensor provided with such a component cannot generate the maximum possible sound pressure. Larger transformer designs than EP6 transformers, for example, cannot fit into the installation space available, however.

Owing to the two-part half-shell core, magnetic interference fields are guided to a not insignificant part from the ferrite material directly through the central limb. The air gap of the core is smoothed in one of the two central limbs 10a, 10b, but the unavoidable residual air gap at the outer limb results in the magnetic resistance at the outer limb only being less than that of the central limb by 10 to 50 times and therefore magnetic interference fields are guided partially through the central limb and an interference voltage is induced in the windings. Moreover, magnetic saturation of the ferrite core used prevents an ultrasonic sensor provided with such an EP transformer from generating a higher sound pressure. The sound pressure that can be achieved determines the maximum achievable range of a distance sensor/echo-sounding system/sonar system to a significant degree, however.

Transformers with an air gap transmit power particularly well when the winding resistance is low when a core which conducts the magnetic flux surrounds the windings, the core material saturates only at high field strengths and when the magnetic field strength is reduced by introducing an air gap.

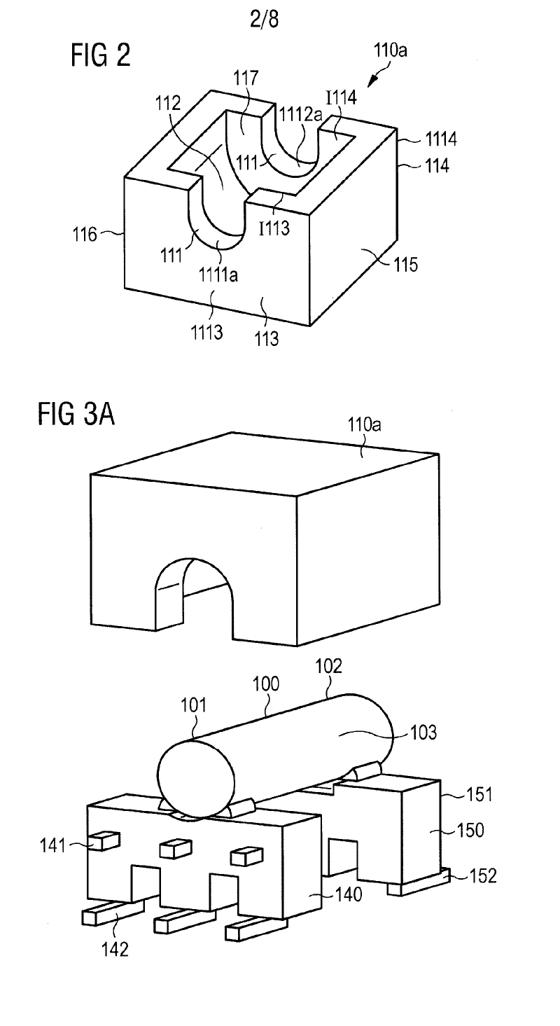

FIG. 2 shows an embodiment of an outer limb 110a of an electrical transformer component 1. The outer limb is in the form of an integral body comprising a base area 112 and at least one side wall. In the embodiment illustrated in FIG. 2, the integral body is hollowed out in its interior in such a way that side walls 113, 114, 115 and 116 are arranged at right angles to one another. The hollow body can also have a different shape, for example, a shape with a cylindrical side wall. By virtue of the arrangement of the base area and at least one side wall 113, 114, 115, 116, a cavity 117 is formed in the integral body. The cavity is open on the side opposite the base area 112. The outer limb 110a has a holding device 111 for holding a central limb of the electrical transformer component. The holding device 111 can be provided on the at least one side wall of the outer limb 110a. In the exemplary embodiment shown in FIG. 2, the holding device 111 comprises a holding element 1111a and a holding element 1112a. The side walls are designed in such a way that the holding element 111 la is formed in the side wall 113 and the holding element 1112a is formed in the side wall 114. The holding elements 1111a and 1112a can each be in the form of a groove in the side walls 113 and 114.

The side walls 113 and 114 are arranged opposite one another in the outer limb 110a shown in FIG. 2. Each of the side walls has an inner face 1113, 1114, which faces the cavity 117, and an outer face A113, A114, which faces away from the cavity 117. The groove 1111a or 1112a extends from the respective inner face 1113 or 1114 of the side faces 113 or 114 up to the respective outer face A113 or A114 of the side faces 113 and 114, respectively.

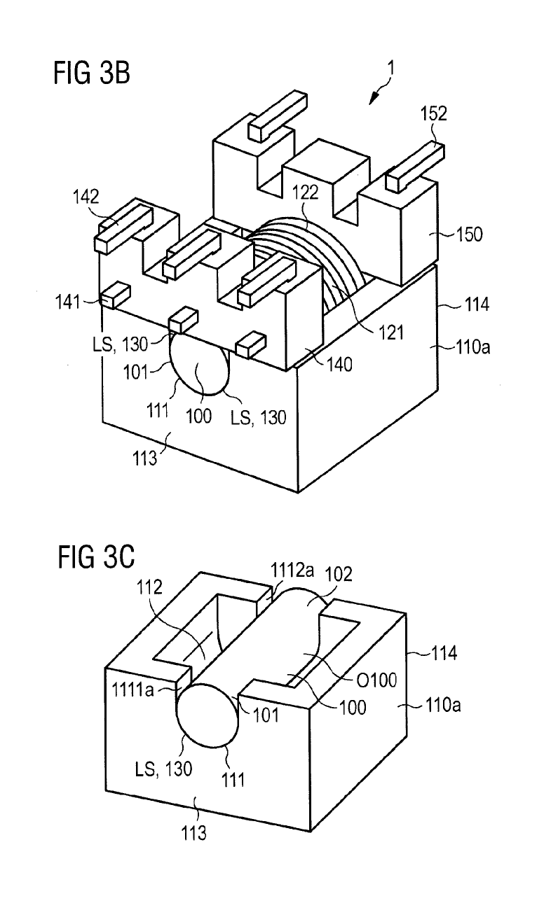

FIG. 3A shows a central limb 100 of the electrical transformer component, which central limb has end sections 101, 102 and a central section 103, which is arranged between the two end sections. In the embodiment of the transformer component explained in FIG. 3A and in all other embodiments of the transformer component, the central limb can be in the form of a rod core. The central limb is fixed at its end sections 101, 102 on in each case one contact-making device 140, 150. At least two wires can be wound immediately onto the central limb 100 and in particular onto the central section 103 of the central limb. The at least two wires can comprise at least one first wire of a primary winding and at least one second wire of a secondary winding. The contact-making device 140 has a contact element 141 for making contact with the at least one first wire of the primary winding. Furthermore, the contact-making device 140 has a contact element 142 for applying a voltage to the at least one first wire. The contact-making device 150 likewise has a contact element 151 for making contact with the at least one second wire of the secondary winding and a contact element 152 for applying a voltage to the at least one second wire.

Furthermore, FIG. 3A shows the outer limb 110a described with reference to FIG. 2. Once the electrical conductor 121 of the primary winding and the electrical conductor 122 of the secondary winding have been wound onto the central limb 100, the outer limb 110a is positioned onto the contact-making devices 140 and 150 in such a way that the end section 101 of the central limb is arranged in the holding element 1111a of the outer limb and the end section 102 of the central limb is arranged in the holding element 1112a. In this case, an air gap is formed between the respective holding elements 1111a and 1112a and the respective end sections 101 and 102 of the central limb which are supported on the holding elements.

Here and in all other embodiments of the transformer component, an air gap is generally understood to mean a gap between two mutually adjoining materials which acts magnetically as a gap filled with air. The gap does not need to be filled with air, however. It is also possible for other materials to be provided in the gap which act magnetically or with respect to the magnetic flux in the same way as a gap filled with air. For example, an adhesive compound can be arranged in the air gap between the holding element 1111a and the end section 101 of the central limb 100 and in the air gap between the end section 102 of the central limb 100, by which adhesive compound the respective end sections of the central limb are fixed on the respective holding elements. As a result, energy can be stored. For example, a material with a permeability of μ=1 can be provided in the air gap, with the result that the gap acts as a gap filled with air. In principle, materials with a low permeability, for example, a permeability of 0.1<μ<200, can be provided in the air gap. Iron powder can be contained in the adhesive, for example.

FIG. 3B shows the finished electrical transformer component 1 comprising the central limb 100 held in the holding device 111, with the at least one first wire 121 of the primary winding and the at least one second wire 122 of the secondary winding being wound onto the central limb in the region of the central section 103. The contact-making devices 140 and 150 on which the central limb 100 is fixed are supported on the side walls 113, 114 of the outer limb 110a. The central limb 100 is connected at the end section 101 to the contact-making device 140 and at the end section 102 to the contact-making device 150. Once the wires 121, 122 have been wound onto the central limb 100 or the central section 103 of the central limb, the outer limb 110a is positioned on the wound central limb or rod core.

In order to fix the central limb to the outer limb 110a, an adhesive 130, for example, a UV-curing adhesive, can be applied to the end sections 101, 102 of the central section 100. As an alternative or in addition, adhesive 130 can be applied to the surface of the holding device 111 and in particular to the holding elements 1111a, 1112a. When the outer limb 110a is positioned onto the end sections 101, 102 of the central limb, the adhesive bridges an air gap LS between the central limb 100 and the outer limb 110a. Once the adhesive 130 has cured, the central limb 100 is fixedly connected to the outer limb 110a.

FIG. 3C shows, for illustrative purposes, the outer limb 110a, which is already illustrated in FIG. 2 and is in the form of a shell core or a cap, and the central limb 100. The central limb 100 is held in the holding elements 1111a and 1112a of the holding device 111. The holding elements 1111a and 1112a are in the form of cutouts in the side walls 113 and 114 of the outer limb 110a. Once the outer limb 110a has been positioned on the central limb 100, the end sections 101 and 102 of the central limb are supported in the holding elements 1111a and 1112a. Adhesive or a material with a low permeability in the region of μ=0.1 . . . 200 can be provided in the gap between the end sections 101, 102 and the holding elements 1111a, 1112. The adhesive can be filled with iron powder, for example. For improved clarity, the contact-making devices 140 and 150 are not illustrated in FIG. 3C.

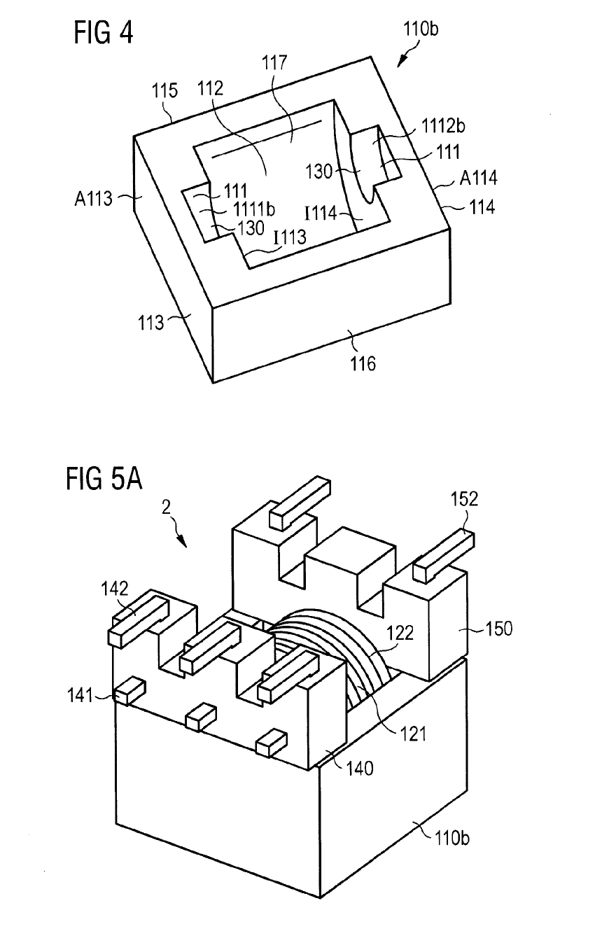

FIG. 4 shows a further embodiment of an outer limb 110b. The outer limb is in the form of a shell core or a core cap, in a similar manner to that shown in FIG. 2. Details are only given below of the differences between the embodiment of the outer limb 110b shown in FIG. 4 and the embodiment of the outer limb 110a shown in FIG. 2. The outer limb 110b has a holding device 111 for holding the central limb 100 on the outer limb. The holding device 111 comprises a holding element 1111b, which is in the form of a depression in the side wall 113 of the outer limb 110b. Furthermore, the holding device 111 comprises a holding element 1112b, which is in the form of a depression in the side wall 114 of the outer limb 110b.

In contrast to the embodiment shown in FIG. 2 of the outer limb 110a, the depressions or cutouts 1111b, 1112b in the side walls 113, 114 of the outer limb 110b are not open towards the respective outer faces A113, A114 of the side walls 113, 114. Instead, the depressions 1111b, 1112b each extend from the inner face 1113, 1114 of the respective side walls 113, 114 which faces the cavity 117 into the respective side walls 113, 114 up to a depth which is less than the thickness of the side walls 113, 114.

Similarly to as shown in FIGS. 3A and 3B, in order to assemble the electrical transformer component 2, the outer limb 110b shown in FIG. 4 is positioned onto the central limb 100 mounted on the contact-making devices 140, 150 by virtue of the central limb being inserted into the holding elements 111 lb and 1112b. An adhesive 130, for example, a UV curing adhesive, can be applied to the surfaces of the end sections 101, 102 of the central limb or to the inner faces of the holding elements 1111b, 1112b so that adhesive is contained in the air gap between the end sections 101, 102 of the central limb and the holding elements. Iron particles can also be contained in the adhesive. In principle, a material with a low permeability, for example, a permeability of 0.1<μ<200 can be provided in the gap.

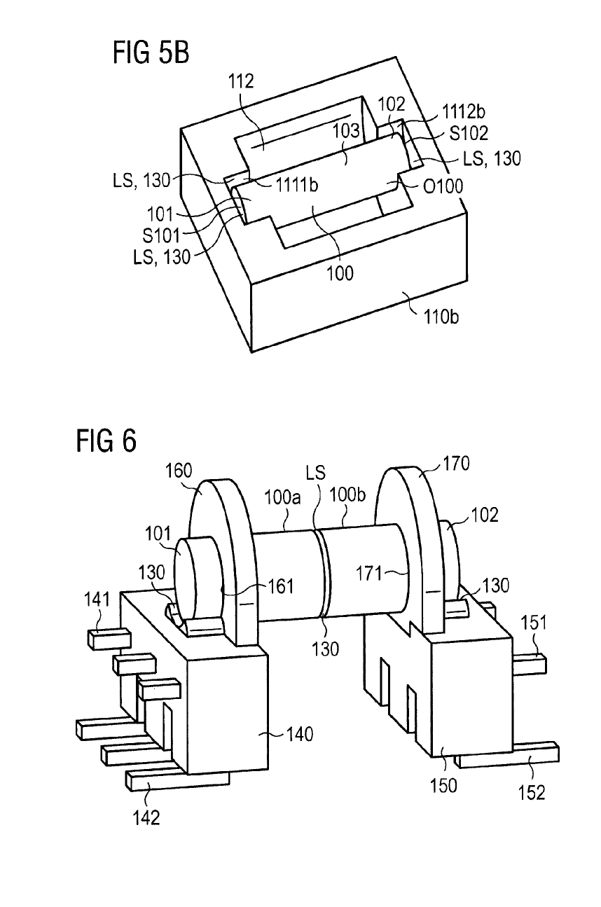

FIG. 5A shows an electrical transformer component 2 once the outer limb 110b has been positioned on the central limb 100, onto which a wire 121 of a primary winding and a wire 122 of a secondary winding have been wound, and after subsequent curing of the adhesive. The central limb 100 is fastened at its end sections 101, 102 on the contact-making devices 140 and 150. The contact-making device 140 has a contact element 141 for terminating the wire 121 wound onto the central limb 100 and a contact element 142 for applying a voltage to the wire 121. Likewise, the contact-making device 150 has a contact element 151 for terminating the wire 122 and a contact element 152 for applying a voltage to the wire 122.

FIG. 5B shows, for illustrative purposes, the central limb 100 held in the holding elements 1111b, 1112b. For improved illustration, the contact-making devices 140 and 150 to which the central limb is fastened are not shown in FIG. 5B. The central limb 100 can be designed in such a way that a gap LS is provided between the support face of the central limb 100 on the holding elements 1111b, 1112b of the outer limb 110b. Likewise, a gap can be provided between the outer limb 110b and end faces S101/S102 of the end sections 101/102 of the central limb. The two gaps can be filled with an adhesive 130 or a material with a low permeability, for example, a permeability of 0.1<μ<200. The adhesive can contain, for example, iron, for example, iron powder.

In contrast to the EP transformer component shown in FIGS. 1A and 1B, in which the wires of the primary and secondary windings are not wound immediately onto the central limb but onto the central tube of a coil former, in the electrical transformer components 1 and 2 in FIGS. 3B and 5A the at least two wires of the primary and secondary windings are wound directly onto the central limb 100 of the core. As a result, the winding space is greater than in a conventional EP transformer. Owing to the direct winding of the central limb 100 and the resultant considerably larger winding space, it is possible to select a greater wire cross section for the wires 121, 122. This reduces the resistance of the winding. Furthermore, the turns number of the wires can be increased owing to the larger winding space.

However, this means that a higher inductance of the secondary winding results with an unchanged air gap. By enlarging the air gap, this generally undesired increase in the inductance of the secondary winding can be counteracted. The enlargement of the air gap at the end sections 101, 102 of the central limb results in the drift of the inductance of the secondary winding owing to temperature fluctuations and aging being less than in conventional EP transformers.

The now larger air gap inevitably results in a reduction in the magnetic field strength, however. This has the desired positive effect on the saturation property of the transformer: the transformer can thus transmit more power, as a result of which, in the case of an ultrasonic echo distance sensor, the sound pressure of the piezoelectric element can be increased and the overall system of the ultrasonic echo distance sensor can detect further removed objects. Furthermore, in the case where the installation space available in the application of an ultrasonic echo distance sensor is intended to be reduced, the same power features as for EP transformers can be achieved.

Moreover, different materials can be used for the central limb 100 and for the outer limb 110a, 110b. For example, a highly saturation-resistant material can be used for the central limb, for example. In particular, the material of the central limb can be more saturation-resistant than the material of the outer limb. For example, a high-saturating ferrite material can be used for the central limb and a highly permeable ferrite material can be used for the outer limb. An air gap can be provided in the central limb. The air gap can be in the form of a real air gap. Such an embodiment will be explained in more detail below with reference to FIG. 6. Furthermore, the air gap can be realized in place of a real air gap in the central limb also by using a suitable material for the central limb. For example, the central limb can be produced from an iron powder and the outer limb from ferrite. If the central limb contains a material consisting of iron powder, an air gap is produced, distributed over the length of the central limb, which air gap is formed between the individual iron powder particles of the iron powder.

In the electrical transformer components 1, 2 from FIGS. 3B and 5A, the outer limb 110a, 110b is formed integrally in the form of a housing or a core cap/full-shell. The rod-shaped central limb 100 is preferably shorter than the length of the housing or than the maximum distance between the lateral limiting faces of the cutouts 1111b, 1112b, as a result of which external interference fields are preferably guided through the outer limb 100b and therefore approximately no or only an extremely low interference voltage is induced in the windings of the transformer component 2. In the embodiment shown in FIG. 5A, in which the outer sides of the grooves 1111b, 1112b in the outer limb 110 are not open outwards but are designed to be magnetically conductive at both ends instead, magnetic interference fields are particularly effectively kept away from the central limb 100 as a result of which a transformer with such a design has particularly good immunity to interference.

FIG. 6 shows an embodiment of a contact-making device 140 comprising contact elements 141 for making contact with the wire 121 and comprising contact elements 142 for applying a voltage to the wire 121 of the primary winding and comprising a contact-making device 150 comprising contact elements 151 for making contact with the wire 122 of the secondary winding and comprising contact elements 152 for applying a voltage to the wire 122. In contrast to the embodiment shown in FIG. 3A, the contact-making device 140 has a flange 160 arranged laterally on the contact-making device and the contact-making device 150 has a flange 170 arranged laterally thereon. The two flanges each have an opening 161 and an opening 171, respectively, through which the central limb 100 can be inserted between the two flanges in such a way that the end section 101 of the central limb 100 is supported on the contact-making device 140 and the end section 102 of the central limb is supported on the contact-making device 150. The two end sections 101 and 102 of the central limb 100 can be fixed to the respective contact-making devices 140 and 150 by an adhesive compound 130.

In addition to the two lateral flanges 160 and 170, the central limb 100 in the embodiment shown in FIG. 6 has an air gap LS. The central limb therefore has two halves 100a and 100b, which are coupled by the air gap LS. As explained already above, the air gap does not need to be filled with air, but can contain a different material, which acts as a gap filled with air in relation to the guidance of the magnetic flux through the central limb. In fact, a material consisting of plastic can also be arranged in the gap, for example.

Half 100a of the central limb 100 is fixed on the contact-making device 140. Half 100b of the central limb 100 is fixed on the contact-making device 150. In order to fix the two halves 100a and 100b of the central limb to one another, an adhesive compound 130 can be provided in the gap. Improved immunity to interference is made possible by virtue of the air gap in the central limb.

The wires 121 and 122 are wound immediately onto that part of the central limb which is arranged between the flanges 160 and 170. The lateral flanges 160 and 170 are formed in such a way that lateral sliding of the wires 121, 122 off from the central limb 100 is prevented.

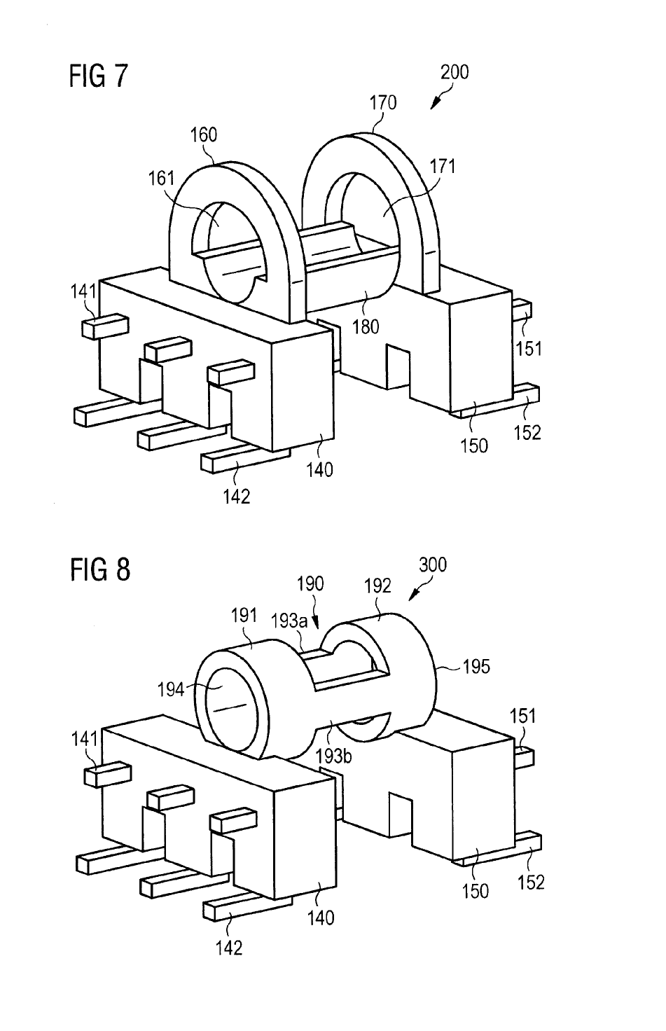

FIG. 7 shows an embodiment of a coil former 200, which can be used together with the central limb 100 and the outer limb 110a, 110b to construct the electrical transformer component. The coil former 200 has a contact-making device 140 for applying a voltage to the wire 121, which can be wound, for example, as primary winding, around the central limb, and a contact-making device 150 for applying a voltage to the wire 122, which can be wound, for example, as secondary winding, around the central limb. The contact-making devices 140, 150 each have a contact element 141 and 151, respectively, for terminating the respective wires 121, 122 at the contact-making devices. Furthermore, the contact-making devices 140, 150 each have a contact element 142, 152 for applying a voltage to the respective wires.

A flange 160 is arranged laterally on the contact-making device 140 and a flange 170 is arranged laterally on the contact-making device 150. In contrast to the embodiment of the contact-making devices which are not connected to one another shown in FIG. 6, the two contact-making devices 140 and 150 in FIG. 7 are connected to one another by a support element 180. The support element 180 is arranged between the two flanges 160 and 170. The support element 180 can be in the form of a part of a wall of a hollow cylinder. The support element 180 can be in the form of half of the central tube 1250 shown in FIG. 1B, for example, and can have a semicircular cross section, for example. The contact-making devices 140 and 150, the lateral flanges 160 and 170 and the support element 180 can be produced from the same material, for example.

In order to produce the electrical transformer component comprising the coil former 200, the central limb 100 is inserted through the openings 161, 171 in the flanges 160, 170 and arranged on the support element 180. Then, the wires 121, 122 are wound onto the support element 180 and that part of the surface of the central limb which does not rest immediately on the support element. The lateral flanges 160 and 170 are designed in such a way that lateral sliding of the wires 121, 122 off from the wound support element 180 and the wound part of the central limb 100 is prevented. Once the winding process has come to an end, the outer limb 100a or 100b is positioned on the coil former 200 and fixed to the coil former, in particular the contact-making devices 140, 150, by an adhesive bond.

FIG. 8 shows an embodiment of a coil former 300, which can be used together with the central limb 100 and the outer limb 110a, 110b for constructing the electrical transformer component. The coil former 300 has a contact-making device 140 for applying a voltage to the wire 121 and a contact-making device 150 for applying a voltage to the wire 122. The contact-making devices 140, 150 each contain a contact element 141, 151 for terminating the respective electrical conductors 121, 122 at the coil former and a contact element 142, 152 for applying a voltage to the electrical conductors 121, 122.

The coil former 300 comprises a central tube 190, which is arranged between the contact-making device 140 and the contact-making device 150. The central tube 190 has a hollow cylinder 191 and a hollow cylinder 192, which are connected to one another via at least one material web 193a, 193b. The at least one material web can be in the form of at least one segment of a hollow cylinder. The width of the at least one material web 193a, 193b which extends in the circumferential direction of the hollow cylinders 191, 192 is less than the circumference of the hollow cylinders 191, 192. Thus, the area of the at least one material web 193a, 193b is less than the outer area of each of the hollow cylinders. If a plurality of webs are arranged between the two hollow cylinders, the webs are not connected to one another, with the result that in each case an air gap is provided between their longitudinal sides, which run in the longitudinal direction of the central tube 190. In the exemplary embodiment shown in FIG. 8, two webs 193a, 193b are arranged between the two hollow cylinders. The hollow cylinders 191 and 192 are connected via the two webs 193a, 193b arranged between the hollow cylinders 191, 192.

The hollow cylinder 191 is fixedly connected to the contact-making device 140. The hollow cylinder 192 is fixedly connected to the contact-making device 150. The contact-making devices 140, 150 and the central tube 190 can be produced from the same material, for example.

When the electrical transformer component is assembled with the coil former 300, the central limb 100 is inserted into the openings 194, 195 in the central tube 190. Then, the wires 121, 122 are wound onto the central tube 190. In this case, the wires 121, 122 are wound immediately onto those surfaces of the central limb which lie between the two webs 193a, 193b once the central limb has been arranged in the central tube. Then, the outer limb 110a or 110b is positioned on the central limb 100 or the coil former 300 and fixedly connected to the central limb 100 or the coil former 300, for example, by an adhesive bond.

When the wires 121, 122 are wound on, the two wires are wound onto a first part of the central section of the central limb. This first part of the central section of the central limb is between the webs 193a, 193b once the central limb has been inserted into the central tube 190. A second and a third part of the central section of the central limb are surrounded by the hollow cylinders 191 and 192. When the wires 121, 122 are wound on, the wires are wound immediately onto the first part of the central section of the central limb. Furthermore, the wires are wound onto the outer surfaces of the hollow cylinders 191 and 192.

In contrast to the coil former 12 shown in FIG. 1B, the coil former 300 does not have any lateral flanges at the lateral ends of the two hollow cylinders 191 and 192. Furthermore, the central tube is interrupted by the two webs 193a, 193b. During winding of the wires onto the central tube 190, the winding space in the case of the coil former 300 is enlarged in comparison with the embodiment of the coil former 12.

In embodiments of the electrical transformer component in which a coil former according to one of the variant embodiments 200 or 300, an outer limb according to one of the embodiments 110a or 110b and the central limb 100, which is arranged on the support element 180 or in the interrupted central tube 190 of the coil former 200, 300, are used, the winding space is considerably enlarged in comparison with an EP transformer with a completely continuous central tube, as shown in FIG. 1B. Since a coil former is still used in the electrical transformer component, however, the winding technology used for EP transformers can be maintained. The central limb 100 and the support element 180 or the two hollow cylinders 191, 192 can have wires wound onto them by “flyers”, for example. A further possibility consists in setting the coil former 200, 300 itself into rotation so that the coil former itself winds the wires 121, 122 onto the central section 103 of the central limb.

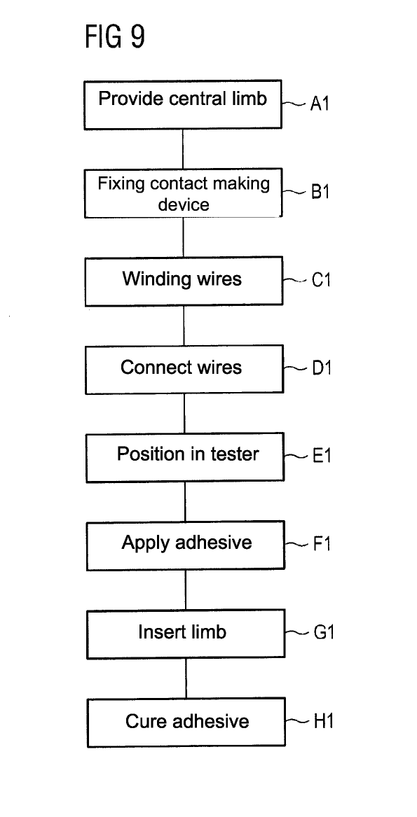

FIG. 9 shows an embodiment of a method for producing an electrical transformer component 1, 2 in accordance with FIGS. 3B and 5A. In one embodiment step A1, first a central limb 100 with end sections 101, 102 and a central section 103 arranged therebetween is provided. The central limb 100 is in the form of a rod-shaped core. Furthermore, an outer limb 110a or an outer limb 110b is provided as an integral component part having a base area 112 having opposite side walls 113, 114, which each have a cutout 1111a, 1112a or 1111b, 1112b. The outer limb 110a, 110b is in the form of a shell-shaped core similar to an EP design, but without the central limb. The cutouts 1111a, 1112a or 1111b, 1112b can be located at that point at which the central limb is located in the case of EP cores. The central limb 100 and the outer limb 110a, 110b can be produced from the same soft-magnetic material.

Furthermore, a first contact-making device 140 for making contact with a first wire 121 and for applying a voltage to the first wire 121 and a second contact-making device 150 for making contact with a second wire 122, which is different from the first wire, are provided. The contact-making devices 140 and 150 are not connected to one another. The contact-making devices 140 and 150 can each have two rows of pins. The pins can in this case be U-shaped and embedded in the material of the contact-making devices, so that the ends of the pins protrude out of the material. The ends of the pins form the contact elements 141, 142 and 151, 152, respectively.

In a step B1, the contact-making device 140 is fixed on the end section 101 of the central limb 100 and the contact-making device 150 is fixed on the end section 102 of the central limb 100. The contact-making devices 140 and 150 can be adhesively bonded to the two end sections 101, 102 of the central limb, for example. This can preferably be performed in an apparatus in which ideally a plurality of nests is provided and which at the same time is used as transportation receptacle.

In a subsequent step C1, the wires 121 and 122 are wound onto the central limb 100. The winding of the central limb 100 can preferably be performed using a flue. For this purpose, preproduced central limbs with their adhesively bonded contact-making devices can be inserted into a winding tool. The winding tool can have two plates consisting of a light-transmissive material. For example, plates consisting of silicone which is light-transmissive at a wavelength of between 350 nm to 410 nm can be used. The two plates can be moved together and apart from one another. Once the central limbs with their adhesively bonded contact-making devices have been inserted into the winding tool, the tool plates of the winding tool are moved together and thus hold the central limb in position. The plates thus form a holder for the central limb. Before this, UV adhesive can be applied to the sides delimiting the winding space. This can also take place continuously during the winding with the aid of a felt material wetted with adhesive. The winding and termination of the wires 121, 122 at the contact elements 141, 151 can take place by a flyer and a retainer. As a result, the wires 121, 122 can be connected to the contact-making devices 140, 150. Finally, UV-curing adhesive can be applied to the wound central limb in order to increase the mechanical rigidity of the coil. Very intensive light with a high UV content can be emitted for a short period of time from flash lamps or UV LEDs located behind the light-transmissive plates, as a result of which UV adhesive, which is exposed to the light, is cured instantaneously. The winding tool can now be opened and the wound core can be removed.

In a subsequent step D1, a soldering process follows, in which the wires terminated at the contact elements 141, 151 are soldered to the contact elements. In a step E1, the wound core is positioned in a test receptacle, which electrically connects the secondary winding to an inductance meter, for example, an LCR meter. In a step F1, adhesive is applied to the end sections 101, 102 of the central limb 100 and/or to the respective cutout 1111a, 1112a or 1111b, 1112b of the side walls 113, 114 of the outer limb 110a, 110b.

In a step G1, the end sections 101, 102 of the central limb are inserted into the respective cutout 1111a, 1112a in the outer limb 110a or into the respective cutout 1111b, 1112b in the outer limb/shell core 110b by virtue of the outer limb 110a, 110b being moved onto the central limb 100 or the central limb 100 being moved onto the outer limb/shell core 110a, 110b. The shell core 110a, 110b can be positioned, by a motor, onto the wound central limb 100. During the movement of the central limb 100 or the outer limb 110a, 110b, an inductance of the wire 122 of the secondary winding can be measured. The movement of the central limb 100 or the outer limb 110a, 110b is stopped if the meshed inductance reaches a preset set point value. The applied adhesive already bridges the air gap between the central limb and the shell core at this time. However, the adhesive is still in the liquid state.

In a step H1, the curing of the adhesive between the end sections 101, 102 of the central limb and the respective cutout 1111a, 1112a or 1111b, 1112b in the outer limb is performed. If UV-curing adhesive has been used, a flash of UV light from a UV-LED array or a flash lamp can be used, for example, to cure the adhesive instantaneously.

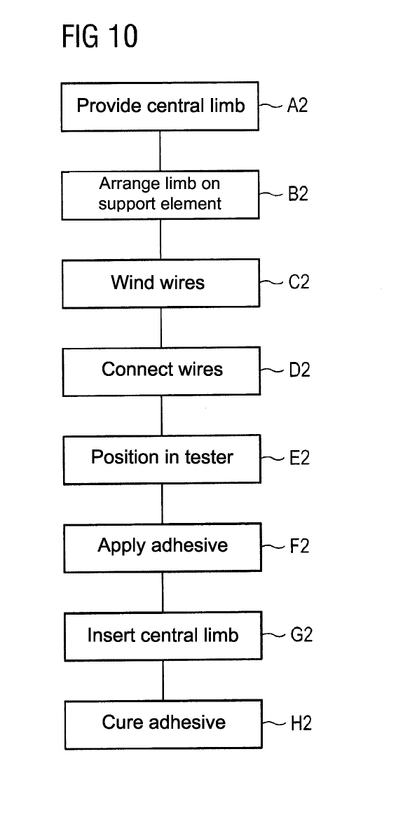

FIG. 10 shows an embodiment of a method for producing an electrical transformer component comprising a coil former 200 or 300. In a step A2, the central limb 100 with the end sections 101, 102 and a central section 103 arranged therebetween is provided. The central limb can be in the form of a rod-shaped core, for example. Furthermore, the outer limb 110a or 110b is provided as an integral component part with a base area 112 comprising mutually opposite side walls 113, 114, which each have a cutout 1111a, 1112a and 1111b, 1112b, respectively. The outer limb 110a, 110b can be provided as a shell-shaped core, similar to an EP design, but without the central limb. The cutout can be provided at the point at which the central limb is located in the case of EP cores. The central limb 100 and the outer limb 110a, 110b can be produced from the same soft-magnetic material.

Furthermore, the coil former 200 with a support element 180 for receiving the central limb 100 is provided, as is illustrated and described with reference to FIG. 7. The coil former 200 furthermore comprises a contact-making device 140 for making contact with the at least one first wire 121 and for applying a voltage to the at least one first wire and a contact-making device 150 for making contact with the at least one second wire 122 and for applying a voltage to the at least one second wire. The two contact-making devices have contact elements 141, 151 for making contact with or terminating the respective wires 121, 122 at the respective contact-making devices 140, 150 and contact elements 142, 152 for applying a voltage to the respective wires 121, 122.

A first flange 160 is arranged on the first contact-making device 140 and a second flange 170 is arranged on the second contact-making device 150. A support element 180 for supporting the central limb 100 is arranged between the first and second flanges, wherein the support element 180 is designed in such a way that, when the central limb is positioned onto the support element, a first part of a surface of the central section 103 of the central limb 100 is supported on the support element 180 and a second part of the surface of the central section 103 of the central limb 100 is not supported on the support element 180.

In a step B2, the central section 103 of the central limb 100 is arranged on the support element 180. The first part of the surface of the central section of the central limb can be adhesively bonded to the support element. In a step C2, the first and second wires 121, 122 are wound onto the support element 180 and the second part of the surface of the central section 103 of the central limb 100. After the winding operation, the wires 121, 122 are connected to the respective contact elements 141, 151 of the contact-making devices 140, 150. This is followed by a soldering process step D2, in which the wire ends terminated at the contact elements 141, 151 are soldered to the contact elements.

In a step E2, the core thus wound is positioned in a test receptacle, which electrically connects the secondary winding to an inductance meter, for example, an LCR meter. In a step F2, an adhesive is applied to the end sections 101, 102 of the central limb and/or to the respective cutout 1111a, 1112a or 1111b, 1112b of the outer limb 110a or 110b. The adhesive can be a UV-curing adhesive.

In a step G2, the end sections 101, 102 of the central limb 100 are inserted into the respective cutout 1111a, 1112a or 1111b, 1112b in the outer limb by virtue of the central limb being moved onto the outer limb or the outer limb being moved onto the central limb until the central limb is arranged in the cutouts. The outer limb can be positioned on the round central limb by a motor, for example. During the movement of the central limb 100 or the outer limb 110a, 110b, an inductance of the wire 122 of the secondary winding is measured. The movement of the central limb 100 or of the outer limb 110a, 110b is stopped when the measured inductance reaches a preset set point value. The adhesive already bridges the air gap between the central limb 100 and the outer limb 110 at this time. However, the adhesive is initially still in a liquid state.

In a step H2, the curing of the adhesive between the end sections 101, 102 of the central limb and the respective cutout 1111a, 1112a or 1111b, 1112b in the side walls 113, 114 of the outer limb 110 is performed. In the case where a UV-curing adhesive is used, a flash of UV light from an UV-LED array or a flash lamp can be used, for example, which cures the adhesive instantaneously.

Anaerobic UV adhesives, but also acrylates, and epoxy resins which are dual-curing, for example, can be used for the adhesive 130. Anaerobic adhesives cure owing to different environmental conditions. These include contact with metal ions, irradiation by UV light and heating of the adhesive to a temperature. Free metal ions need to hit in particular surfaces of ferrite workpieces. The curing of uncured adhesive residues can take place either with more time or accelerates as a result of contamination of the bonding points with metal ions, in particular copper ions. Furthermore, the curing can take place by storage of the finished component parts at temperatures of 100° C. or higher temperatures for a few minutes.

1-15. (canceled)

16. An electrical transformer component, comprising:
a central limb comprising a first end section, a second end section and a central section arranged between the first and second end sections;
an outer limb comprising a holding device for holding the central limb on the outer limb, wherein at least one of the first and second end sections of the central limb is held on the holding device of the outer limb; and
a first wire and a second wire wound directly onto a surface of the central section of the central limb.

17. The electrical transformer component according to claim 16,
wherein the outer limb comprises an integral body with a base area and a side wall, wherein the base area and the side wall form a cavity in the integral body, wherein the cavity is open on a side opposite the base area; and
wherein a surface of the central limb is surrounded at least partially by the base area and the side wall of the integral body.

18. The electrical transformer component according to claim 17, wherein the side wall of the integral body has the holding device.

19. The electrical transformer component according to claim 17,
wherein the outer limb has a first side wall and a second side wall arranged opposite the first side wall;
wherein the first side wall and the second side wall each have an inner face that faces the cavity and an outer face that faces away from the cavity;
wherein the holding device comprises a first holding element and a second holding element;
wherein the first side wall has the first holding element and the second side wall has the second holding element; and
wherein the first end section of the central limb is held on the first holding element and the second end section of the central limb is held on the second holding element.

20. The electrical transformer component according to claim 19, wherein the first holding element comprises a groove that extends through the first side wall from the inner face to the outer face; and
wherein the second holding element comprises a groove that extends through the second side wall from the inner face to the outer face.

21. The electrical transformer component according to claim 20, wherein the central limb is shorter than a distance between the outer face of the first side wall and the outer face of the second side wall.

22. The electrical transformer component according to claim 19,
wherein the first holding element comprises a depression in the inner face of the first side wall, the depression having a depth that is less than a thickness of the first side wall; and
wherein the second holding element comprises a depression in the inner face of the second side wall, the depression having a depth that is less than a thickness of the second side wall.

23. The electrical transformer component according to claim 16, wherein the central limb and the outer limb comprise different materials.

24. The electrical transformer component according to claim 16, wherein the central limb has an air gap.

25. The electrical transformer component according to claim 24, further comprising an adhesive disposed in the air gap.

26. The electrical transformer component according to claim 16, wherein the central limb is held on the holding device in such a way that an air gap is provided between the outer limb and the central limb.

27. The electrical transformer component according to claim 26, further comprising an adhesive disposed in the air gap.

28. The electrical transformer component according to claim 16, further comprising:
a first contact-making device, which has a first contact element making contact with the first wire and a second contact element for applying a voltage to the first wire; and
a second contact-making device, which has a first contact element making contact with the second wire and a second contact element for applying a voltage to the second wire, wherein the first and second contact-making devices are not connected to one another;
wherein the first end section of the central limb is fixed on the first contact-making device and the second end section of the central limb is fixed on the second contact-making device.

29. The electrical transformer component according to claim 16, further comprising:
a coil former comprising a first contact-making device making contact with the first wire and for applying a voltage to the first wire and also comprising a second contact-making device making contact with the second wire for applying a voltage to the second wire, wherein a support element that supports the central limb is arranged between the first contact-making device and the second contact-making device; and
wherein the support element is designed in such a way that a first part of a surface of the central section of the central limb is supported on the support element and a second part of the surface of the central section of the central limb is not supported on the support element.

30. A method for producing an electrical transformer component, the method comprising:
providing a central limb comprising a first, a second end section and a central section arranged between the first and second end sections;
providing an outer limb as an integral component part comprising a base area having mutually opposite first and second side walls that each have a cutout,
providing a first contact-making device for making contact with a first wire and a second contact-making device for making contact with a second wire, which is different than the first wire, wherein the first and second contact-making devices are not connected to one another;
fixing the first contact-making device on the first end section of the central limb and fixing the second contact-making device on the second end section of the central limb;
winding the first and second wires around the central limb;
connecting the first wire to the first contact-making device and connecting the second wire to the second contact-making device;
applying an adhesive to the first and second end sections of the central limb and/or to a respective cutout of the first and second side walls;
inserting the first and second end sections of the central limb into the respective cutout of the first and second side walls by moving the outer limb and/or moving the central limb;
measuring an inductance of the second wire during movement of the outer limb and/or movement of the central limb;
stopping the movement of the outer limb and/or the movement of the central limb when the measured inductance reaches a preset set point value; and
curing the adhesive between the first and second end sections of the central limb and the respective cutout of the first and second side walls of the outer limb.

31. A method for producing an electrical transformer component, the method comprising:
providing a central limb comprising a first end section, second end section and a central section arranged therebetween;
providing an outer limb as an integral component part comprising a base area comprising mutually opposite first and second side walls, which each have a cutout;
providing a coil former comprising a first contact-making device for making contact with a first wire and comprising a second contact-making device for making contact with a second wire, wherein a support element for supporting the central limb is arranged between the first contact-making device and the second contact-making device, wherein the support element is designed in such a way that, when the central limb is positioned on the support element, a first part of a surface of the central section of the central limb is supported on the support element and a second part of the surface of the central section of the central limb is not supported on the support element;
arranging the central section of the central limb on the support element;
winding the first and second wires around the support element and the second part of the surface of the central section of the central limb;
connecting the first wire to the first contact-making device and connecting the second wire to the second contact-making device;
applying an adhesive to the first and second end sections of the central limb and/or to a respective cutout of the first and second side walls of the outer limb;
inserting the first and second end sections of the central limb into the respective cutout in the first and second side walls by moving the outer limb and/or moving the central limb;
measuring an inductance of the second wire during movement of the outer limb and/or movement of the central limb;
stopping the movement of the outer limb and/or the movement of the central limb when the measured inductance reaches a preset set point value; and
curing the adhesive between the first and second end sections of the central limb and the respective cutout of the first and second side walls of the outer limb.
